(19) United States
(12) Patent Application Publication
(10) Pub. No.: US 2022/0297293 A1
(43) Pub. Date: Sep. 22, 2022

(54) DYNAMIC TORQUE SATURATION LIMITS FOR ROBOT ACTUATOR(S)

(71) Applicant: X Development LLC, Mountain View, CA (US)

(72) Inventor: Robert Wilson, Pacifica, CA (US)

(21) Appl. No.: 17/208,721

(22) Filed: Mar. 22, 2021

(51) Int. Cl. B25J 9/16

(52) U.S. Cl. CPC B25J 9/1633; B25J 9/163; B25J 9/1653; B25J 9/1664

(57) ABSTRACT

Implementations are directed to, for each of one or more joints of a robot, generating dynamic joint torque saturation limits for the joint, such as an upper joint torque saturation value and a lower joint torque saturation value. Implementations are additionally or alternatively directed to utilizing the dynamic torque saturation limits for the joint in generating driving torques and/or to driving a motor (or other actuator) of the joint based on the driving torques. Various implementations can enable regulation of contact forces for a robot in situations where the robot lacks joint torque sensor(s) and/or force torque sensor(s) and/or in situations where such sensor(s) are present, but have failed or are malfunctioning.

### BACKGROUND

Regulating contact forces between a robotic manipulator (e.g., a gripper or other end effector) and environmental object(s) can be important for various robots and/or various robot operational environments (e.g., unstructured environments). For example, regulating contact forces can mitigate the risk of the robotic manipulator damaging environmental object(s) by applying too much force to the environmental object(s) and/or can mitigate the risk of component(s) of the robot being damaged as a result of applying too much force to the environmental object(s).

Some approaches to regulate contact forces involve the use of multiple joint torque sensors. Each of the joint torque sensors can be provided at a corresponding one of multiple joints of the robot, and each joint torque sensor can provide a direct measurement of the torque actually being applied by its corresponding joint. These direct measurements can enable determination, by a robot controller, of when a greater than desired degree of force is being exerted and can enable the robot controller to make corresponding adjustment(s) to remediate such a situation.

Some approaches to regulate contact forces additionally or alternatively involve the use of force torque sensor(s), such as a force torque sensor at the robotic manipulator itself. Such a force torque sensor can provide a direct measurement of the force being applied by the robotic manipulator. The direct measurement can enable determination, by a robot controller, of when a greater than desired degree of force is being exerted and enable the robot controller to make corresponding adjustment(s).

While the aforementioned approaches can enable regulation of contact forces in the robotics context, they require the use of sensor(s) that can be cost and/or space prohibitive to implement. For example, economic constraints for a robot can prevent inclusion of such sensor(s) on the robot and/or space constraints of the robot can prevent inclusion of such sensor(s). Further, the sensor(s) are subject to failure and/or other malfunction(s), which can cause hampered (or no) contact force regulation.

### SUMMARY

Implementations disclosed herein are directed to, for each of one or more joints of a robot, generating dynamic joint torque saturation limits for the joint (e.g., an upper joint torque saturation value and a lower joint torque saturation value), utilizing the dynamic torque saturation limits for the joint in generating driving torques, and/or driving a motor (or other actuator) of the joint based on the driving torques.

As one example, during implementation of one or more motion commands for the joint, multiple different joint torque saturation limits can be generated at different time steps and a corresponding given set (e.g., a single pair of an upper and lower joint torque saturation value) can be active at any given time. Further, a sequence of commanded torque values can be generated by a feedback controller during implementation of the motion command(s), and can be generated based on the motion command(s) and corresponding current feedback value(s). A sequence of driving torque values, that are used in driving the motor (e.g., corresponding sinusoidal currents can be provided to the motor) can be generated based on the commanded torque values, but with the commanded torque values bounded by the torque saturation limits that are active at the corresponding time. For example, a driving torque value at a given time can be the commanded torque value at the given time if the commanded torque value is between the active torque saturation limits. However, the driving torque value can be the lower torque saturation limit if the commanded torque value is equal to or below the active lower torque saturation limit, and can be the upper torque saturation limit if the commanded torque value is equal to or above the upper torque saturation limit.

In these and other manners, techniques disclosed herein enable the motor to track the commanded torque values, that are generated by the feedback controller (e.g., a joint position controller), in situations where external force(s) are not being applied through contact of the robot with the environment and where the joint torque saturation limits are accurate. While enabling tracking the commanded torque values generated by the feedback controller in such situations, techniques also enable saturation of the motor torque in situations where external force(s) cause the commanded torque values to exceed the active joint torque saturation limits. Accordingly, in contrast to computed torque feedforward approaches (which command the modeled torques directly to the motor), techniques disclosed herein can rely entirely on closed loop feedback in the feedback controller, allowing the feedback controller to take advantage of joint friction to hold the manipulator against friction with less power and without the need to explicitly model the friction. Further, in contrast to low impedance approaches (which reduce the controller gains to facilitate controlling contact forces/torques but may degrade tracking performance in the presence of small disturbances or modeling errors), techniques disclosed herein can preserve full tracking performance and error rejection up until an external disturbance causes the commanded torque value to exceed the active joint torque saturation limits and/or a modeling error exceeds allowed discrepancy. Further, techniques disclosed herein can enable regulation of contact forces without necessitating utilization of a joint torque sensor and/or a force torque sensor. This can enable regulation of contact forces for a robot in situations where such sensor(s) are absent from a robot and/or in situations where such sensor(s) have failed or are malfunctioning.

In generating dynamic joint torque saturation limits, for a given joint and at a given time, a predicted torque value for the given joint and at the given time can first be generated. The predicted torque value can reflect an estimate of the internal, non-contact joint torques of the given joint at the given time, such as the joint torques required to hold the arm against gravity, to accelerate the arm along a particular trajectory, to overcome friction in the joint due to motion, and/or other joint torque(s). The predicted torque value can be generated using one or more models (e.g., a dynamic model, a mass model, and/or other model(s)). The predicted torque value for the robot joint can be based on one or more of various values, such as a current measured or estimated state of the robot joint (e.g., a joint space position and/or a cartesian space position, a joint space velocity, a joint space acceleration, and/or other state value(s)), a current measured or estimated state of additional robot joint(s) (e.g., based on an overall configuration of the robot), component(s) of a motion command (or intermediate motion command) to be achieved by the robot joint, environmental condition(s), a known payload of the robot, and/or other value(s).

As one example, the predicted torque value can be a function of a predicted gravity torque value that is generated based on a state of the given joint and/or additional joint(s), and optionally based on a mass model. The state of the given joint and/or of additional joints can be a predicted state (e.g., predicted based on implemented motion command(s)) and/or a measured state (e.g., based on feedback from joint position sensor(s) and/or other sensor(s)). As another example, the predicted torque value can additionally or alternatively be a function of a predicted angular acceleration torque value that is generated based on an acceleration component for the robot joint, and optionally based on a mass model. The acceleration component can be based on a predicted acceleration component, a measured acceleration component, and/or the acceleration component of a motion command (or an intermediate motion command). As yet another example, the predicted torque value can additionally or alternatively be a function of a friction torque that is generated based on a velocity component and/or position component for the robot joint. The velocity component and the position component can each be based on predictions, measurements, and/or a motion command (or intermediate motion command). As yet other examples, the predicted torque value can additionally or alternatively be a function of a predicted centripetal force and/or a predicted Coriolis force generated based on a measured, estimated, or commanded velocity component and a robot configuration. As yet another example, the predicted torque value can additionally or alternatively be a function of a predicted motor cogging torque generated based on a measured motor position of a motor of the robot joint.

The joint torque saturation limits can then be generated based on the predicted torque value. For example, an upper joint torque saturation value can be generated based on adding a value to the predicted torque value and a lower joint torque saturation value can be generated based on subtracting the value, or an alternate value, from the predicted torque value. Accordingly, the upper and lower joint torque saturation values will bound the predicted torque value. The bounding will be symmetric when the same value is used in generating both the upper and lower joint torque saturation values, and asymmetric when different values are used. In some implementations, the value, and optional alternate value, utilized in generating the upper and lower torque saturation limits can be fixed. Although the value and/or alternate value are fixed in those implementations, the upper and lower torque saturation limits will still be dynamic as they will also depend on the dynamically determined predicted torque value. In some implementations, the value and/or optional alternate value, utilized in generating the upper and lower torque saturation limits can be selected from a plurality of candidate values. For example, when selected from a plurality of candidate values, the value and/or alternate value can be selected based on user interface input (e.g., a human user selecting the value(s)), based on a determination of whether any human(s) are predicted to be present (e.g., selecting smaller value(s) when human as present), and/or based on a determination of whether an interaction with an environmental object is predicted to occur (e.g., selecting larger value(s) when such an interaction is predicted). In various implementations, the value, and optional alternate value, can be fixed or can have a minimum threshold in order to account for expected error in generating the predicted torque value. For example, the fixed value can be set to account for expected error from the model used in generating the predicted torque value (e.g., error due to not modelling all source(s) of torque and/or inaccuracy in modelling of source(s) of torque).

In various implementations, a motion command for a robot joint can be provided to a joint position controller or other feedback controller. The joint position controller can be, for example, a proportional-integral controller, a proportional-integral-derivative controller, or other closed-loop feedback controller that generates a sequence of commanded torques based on the motion command (or an intermediate motion command as described herein) and based on observed feedback. The sequence of commanded torques seek to control the motor to achieve the motion command for the robot joint, while taking into account observed feedback. For instance, the joint position controller can generate a given torque command as a function of a position component and/or a velocity component of the motion command, and as a function of an observed current position and/or observed current velocity of the robot joint. The generated torque commands can be provided to a saturation block, such as a saturation block of a driver of a motor for the robot joint. The saturation block can optionally include anti-windup feature(s), and integral values, generated by the joint position controller, can optionally be provided to the saturation block for use by the anti-windup feature(s).

A sequence of joint torque saturation limits can also be generated and provided to the saturation block. The sequence of joint torque saturation limits can be generated in process(es) that run separate from the process(es) that implement the feedback controller. For example, the sequence of joint torque saturation limits can be generated by separate processor(s) and/or in separate processing thread(s). The joint torque saturation limits are generated during generation of the sequence of commanded torques by the feedback controller and can each be generated based on a corresponding current state of the robot joint and/or based on the motion command (or an intermediate motion command as described herein), such as based on an acceleration component and/or a velocity component of the motion command. The joint torque saturation limits can be generated and/or provided at the same frequency that torque commands are generated or, alternatively, can be generated at a higher or lower frequency.

The saturation block, in generating a driving torque value at a given time, can generate the driving torque value based on the current commanded torque value and the currently active joint torque saturation limits. For example, the saturation block can generate a driving torque value based on the current commanded torque value (and without reference to the currently active saturation limits) when the current commanded torque is within the currently active saturation limits. For instance, the driving torque value can be equal to the commanded torque value in such a situation. However, the saturation block can generate the driving torque value based on the upper torque saturation value (and without reference to the current commanded torque value) when the current commanded torque value is equal to or above the upper torque saturation value and can generate the driving torque value based on the lower torque saturation value (and without reference to the current commanded torque value) when the current commanded torque value is equal to or below the lower torque saturation value. The generated driving torque values are used in controlling the motor. For example, the driver can generate a sinusoidal current that corresponds to the driving torque values and the sinusoidal current can be provided to the motor.

As referenced above, in some implementations an intermediate motion command can be at least selectively generated (e.g., when it is determined that commanded torque values violate current joint torque saturation limits). The generated intermediate motion command is based on, but differs from, the current motion command. When the intermediate motion command is generated, it can be provided to the feedback controller, in lieu of the motion command, for at least a period of time (e.g., until it is determined commanded torque values no longer violate current joint torque saturation limits). The intermediate motion command can include a position component and/or a velocity component that have the same direction as their counterparts in the motion command, but that are lessened in magnitude relative to their counterparts. Such intermediate motion commands can effectively cause modification of a trajectory of the robot joint, where the modified trajectory is still in the direction of the trajectory of the original motion command and where the original motion command can still be achieved when it is again utilized by the feedback controller in lieu of the intermediate motion commands.

As mentioned, in some implementations the intermediate motion commands can be generated and utilized when it is determined that commanded torque value violates current torque saturation limits. Such a determination can be based on comparing a current commanded torque value (e.g., based on sampling the output from the feedback controller) to a current driving torque value (e.g., based on sampling the output from the saturation block). For example, if the current commanded torque value and the current driving torque value differ (at all or by at least a threshold), it can be determined that the commanded torque value violates current torque saturation limits. Further, the degree to which the magnitude(s) of the component(s) of the intermediate motion command is lessened, relative to motion command counterpart(s), can be based on the extent to which the current commanded torque value and the current driving torque value differ. For example, as the difference between the current commanded torque value and the current driving torque value increases, the degree of lessening can increase. Updated intermediate motion commands can continue to be generated and utilized until it is determined that a current commanded torque value no longer violates the current torque saturation limits. A generated intermediate motion command can differ from a preceding or following intermediate motion command as a result of, for example, being based on a degree to which the current torque saturation limits are violated (e.g., being based on a magnitude of the difference between the current commanded torque value and the current driving torque value).

In some implementations, the saturation block is implemented at the driver and optionally in conjunction with anti-windup feature(s). In some of those implementations, selectively generating and utilizing the intermediate motion commands can prevent jerky movement and/or overshooting when the motor comes out of saturation, as a dampened intermediate motion command will be input to the feedback controller, in lieu of the original motion command, when the motor comes out of saturation. When the motor comes out of saturation, the original motion command can again be input to the feedback controller, in lieu of the intermediate motion command.

In some implementations, the saturation block is implemented separate from the driver, such as in a process functionally interposed between the feedback controller and the driver. For example, the process can run separate from the process(es) that implement the feedback controller and/or separate from the process(es) that generate the torque saturation limits. In some of those implementations, the driving torque generated by the saturation block is provided to the driver for implementation. Further, in some of those implementations, the intermediate motion commands can be generated whenever current torque saturation limits are determined to be violated, effectively implementing dynamic motor torque saturation without necessitating that the saturation block be available directly at the driver. Although this can result in driving torques that deviate above and/or below the dynamic saturation limits in situations where a frequency of the saturation block is less than a frequency of the driver, the deviation can be minimal and a saturation block effectively achieved.

The preceding is provided as an overview of only some implementations disclosed herein. Further description, of these and other implementations, is provided below.

It should be appreciated that all combinations of the foregoing concepts and additional concepts described in greater detail herein are contemplated as being part of the subject matter disclosed herein. For example, all combinations of the claimed subject matter are contemplated as being part of the subject matter disclosed herein.

### BRIEF DESCRIPTION OF THE DRAWINGS

FIG. 1 schematically depicts an example environment in which disclosed techniques can be employed, in accordance with various implementations.

FIG. 2 depicts various example methods in accordance with various implementations.

FIG. 3 depicts an example of sinusoidal currents corresponding to: model predicted torque values, upper torque saturation values, lower torque saturation values, model predicted torque values, and driving torque values.

FIG. 4 schematically depicts an example architecture of a robot.

### DETAILED DESCRIPTION

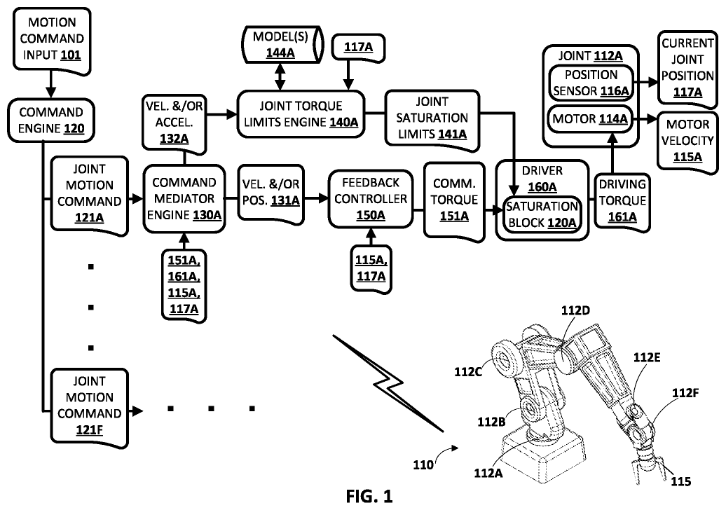

FIG. 1 illustrates an example robot 110, that takes the form of a robot arm. The robot 110 includes six joints 112A-112F and a robotic manipulator 115, that takes the form of a grasping end effector. Each of the joints 112A-112F can be controlled by a corresponding motor or other actuator according to implementations described herein.

While robot 110 is illustrated in FIG. 1, it is noted that additional and/or alternative robots can be utilized with techniques disclosed herein, such as additional robots that vary in one or more respects from robot 110. For example, techniques disclosed herein can instead or additionally be utilized with a mobile forklift robot, a robot arm, an unmanned aerial vehicle (“UAV”), a wheeled telepresence robot, and/or a humanoid robot.

Robot 110 also includes one or processor(s), drivers, motors, analog electrical component(s), and/or other components that can be utilized in implementing one or more aspects of techniques disclosed herein. For example, FIG. 1 also illustrates a command engine 120, a command mediator engine 130A, a joint torque limits engine 140A, a feedback controller 150A, a driver 160A, and a saturation block 120A. In some implementations, such component(s) can be implemented by processor(s) of the robot 110, such as central processing unit(s), programmable logic controller(s), and/or other processor(s). In some of those implementations, different component(s) can be executed on different processor(s) and/or in different thread(s) than other of the component(s).

In FIG. 1, a motion command input 101 is illustrated being provided to command engine 120. The motion command input 101 can be generated based on, for example, user interface input from a human (e.g., teleoperating or otherwise controlling the robot 110) and/or by a higher level task planner of the robot (e.g., one that generates a sequence of motion command inputs to perform a task such as grasping). The command engine 120 can generate, based on the motion command input 101, joint motion commands 121A-F. For example, the motion command input 101 can be in Cartesian space (e.g., defining movement of the end effector 115 in Cartesian space) and the command engine 120 can generate joint motion commands 121A-F that are in joint space. Joint motion command 121A is for joint 121A, joint motion command 121F is for joint 112F, and joint motion commands 121B-E (not illustrated, but represented by the vertical ellipsis) can be for respective ones of joints 112B-E.

An example of processing, of the joint motion command 121A, is now described with respect to various components that are specific to the joint 112A. As represented by the horizontal ellipsis in FIG. 1, other of the joint motion commands 121B-F can likewise be processed by corresponding components that are specific to corresponding joints. However, for the sake of simplicity, only the processing that is relevant to joint 112A is described in detail.

The joint motion command 121A is provided to the command mediator engine 130A. In at least an initial iteration, the command mediator engine 130A can provide component(s) of the joint motion command 121A to the feedback controller 150A and, optionally, to the joint torque limits engine 140A.

In some subsequent iteration(s), the command mediator engine 130A can generate a corresponding intermediate motion command, and provide component(s) of the intermediate motion command to feedback controller 150A and/or the joint torque limits engine 140A, and provide those component(s) in lieu of component(s) of the original joint motion command 121A.

For example, and as illustrated in FIG. 1, a most recent commanded torque value 151A, a most recent driving torque value 161A, and, optionally, a most recent motor velocity 115A and/or a most recent current joint position 117A can be fed back to the command mediator engine 130A at each of a plurality of time steps. The command mediator engine 130A can compare the most recent commanded torque value 151A and the most recent driving torque value 161A and, when the comparison indicates that they don't match, can determine the motor 114A is in saturation. In response to determining the motor is in saturation, the command mediator engine 130A can generate an intermediate motion command that includes component(s) (e.g., velocity and/or position) with magnitudes that are lessened relative to their counterparts in the joint motion command 121A. In some implementations, a degree to which they are lessened can be based on a degree of the difference between the most recent commanded torque value 151A and the most recent driving torque value 161A. For example, they can be lessened to a lesser extent (i.e., have a greater magnitude) when the difference is 0.1 newton-meter as compared to when the difference is 1.5 newton-meter. Put another way, for a given original motion command, the magnitudes of the generated intermediate motion commands would be greater with a difference of 0.1 newton-meter than if the difference were instead 1.5 newton-meter. In some implementations, in generating the intermediate motion command, the command mediator engine 130A can additionally and/or alternatively generate the intermediate motion command based on the most recent motor velocity 115A and/or the most recent current joint position 117A. When the command mediator engine 130A determines the motor 114A is no longer in saturation, the command mediator engine 130A can again provide the original joint motion command 120A.

In the example of FIG. 1, the command mediator engine 130A provides velocity and/or position component(s) 131A to feedback controller 150A and optionally provides velocity and/or acceleration component(s) 132A to joint torque limits engine 140A. When the motor is not determined to be in saturation, the component(s) 131A and 132A can be of the joint motion command 121A. In some implementations, and when the motor is determined to be in saturation, the component(s) 131A and 132A can be of a corresponding intermediate motion command.

Feedback controller 150A utilizes velocity and/or position component(s) 131A and a most recent motor velocity 115A and/or a most recent current joint position 117A to generate a commanded torque 151A. In some implementations, feedback controller 150A is a joint position controller and is a proportional-integral controller, a proportional-integral-derivative controller, or other closed-loop feedback controller.

Joint torque limits engine 140A utilizes one or more model(s) 144A in generating a predicted torque value. The predicted torque value at a given time can reflect an estimate of the internal, non-contact joint torques of the joint 112A at the given time, such as the joint torque(s) required to hold the arm against gravity, accelerate the arm along a particular trajectory, overcome friction in the joint due to motion, etc. In some implementations, the joint torque limits engine 140A generates the predicted torque value based on one or more model(s) and one or more of: a current measured or estimated state of the robot joint; a current measured or estimated state of additional robot joint(s); component(s) of a motion command (or intermediate motion command) to be achieved by the robot joint and/or other robot joint(s); environmental condition(s); a known payload of the robot; and/or other value(s). In some of those implementations, the torque limits engine 140A generates one or more discrete predicted torque values, and generates the predicted torque value as a function of the one or more discrete predicted torque values.

In generating the predicted torque value, the joint torque limits engine 140A can apply the most recent current joint position 117A, of joint 112A, to one or more of the model(s) 144A and/or most recent current joint position(s) for other of the joint(s) 112B-F, to one or more of the model(s) 144A. For example, the joint torque limits engine 140A can generate a predicted gravity torque value that is based on applying the most recent current joint position 117A, and most recent current joint position(s) for other of the joint(s) 112B-F, to one of the model(s) 144A. The joint torque limits engine 140A can generate the predicted torque value based at least in part on the predicted gravity torque value.

In generating the predicted torque value, the joint torque limits engine 140A can additionally or alternatively apply the component(s) 132A to one or more of the model(s) 144A. For example, the joint torque limits engine 140A can generate a predicted angular acceleration torque value that is generated based on an acceleration component of the component(s) 132A and/or a predicted coulomb friction torque value that is based on a velocity component of the component(s) 132A. The joint torque limits engine 140A can generate the predicted torque value based at least in part on the predicted angular acceleration torque value and/or the predicted coulomb friction torque value.

Joint torque limits engine 140A further generates joint saturation limits 141A based on the predicted torque value. For example, joint torque limits engine 140A can generate an upper joint torque saturation value by adding a value to the predicted torque value and can generate a lower joint torque saturation value based on subtracting the value, or an alternate value, from the predicted torque value. Accordingly, the upper and lower joint torque saturation values will bound the predicted torque value. In some implementations, the value, and optional alternate value, utilized in generating the upper and lower torque saturation limits can be fixed. In some implementations, joint torque limits engine 140A selects the value and/or optional alternate value, utilized in generating the upper and lower torque saturation limits, from a plurality of candidate values.

The commanded torque is provided, by the feedback controller 150A, to saturation block 120A. Further, the joint saturation limits 141A are provided, by the joint torque limits engine 140A, to the saturation block 120A. As described herein, new joint saturation limits 141A can be calculated at each iteration by joint torque limits engine 140A and based on new feedback value(s) and/or a new intermediate motion command. Likewise, new commanded torque values 151A can be calculated at each iteration by feedback controller 150A and based on new feedback value(s) and/or a new intermediate motion command. In some implementations joint torque limits engine 140A and feedback controller 150A operate at the same frequency (meaning new commanded torque values 151A and new joint saturation limits 141A will be provided to saturation block 160A at the same frequency). In some other implementations, joint torque limits engine 140A and feedback controller 150A operate at different frequencies.

Saturation block 120A generates a driving torque value 161A based on the current commanded torque value 151A and the current joint torque saturation limits 141A. For example, the saturation block 120A can generate the driving torque value 161A based on the current commanded torque value 151A (and without reference to the current joint saturation limits 141A) when the current commanded torque value 151A is within the bounds of the current joint saturation limits 141A. For instance, the driving torque value can be equal to the commanded torque value 151A in such a situation. However, the saturation block 120A can generate the driving torque value 161A based on the upper torque saturation value of the joint saturation limits 141A when the current commanded torque value 151A is equal to or above the upper torque saturation value and can generate the driving torque value 161A based on the lower torque saturation value of the joint saturation limits 141A when the current commanded torque value 151A is equal to or below the lower torque saturation value.

Although saturation block 120A is illustrated in FIG. 1 as being part of driver 160A, in some implementations the saturation block 120A can instead be functionally interposed between feedback controller 150A and driver 160A, and provide the generated driving torque value 161A to driver 160A.

Driver 160A uses the driving torque value 161A in controlling the motor 114A of the joint 112A. For example, the driver 160A can generate a sinusoidal current that corresponds to the driving torque values 161A that are generated over multiple iterations and the sinusoidal current can be provided to the motor 114A. A current motor velocity 115A for the motor can be determined using, for example, sensor(s) of the motor 114A, and fed back to various component(s) as described herein. Also, a position sensor 116A of the joint 112A can also generate a current joint position 117A that can be fed back to various component(s) as described herein. Various values described herein as being fed back can optionally be sampled periodically and the sampled values fed back.

As appreciated from the above description, updated values are iteratively generated by and passed to and from various components in controlling the motor 114A according to techniques described herein.

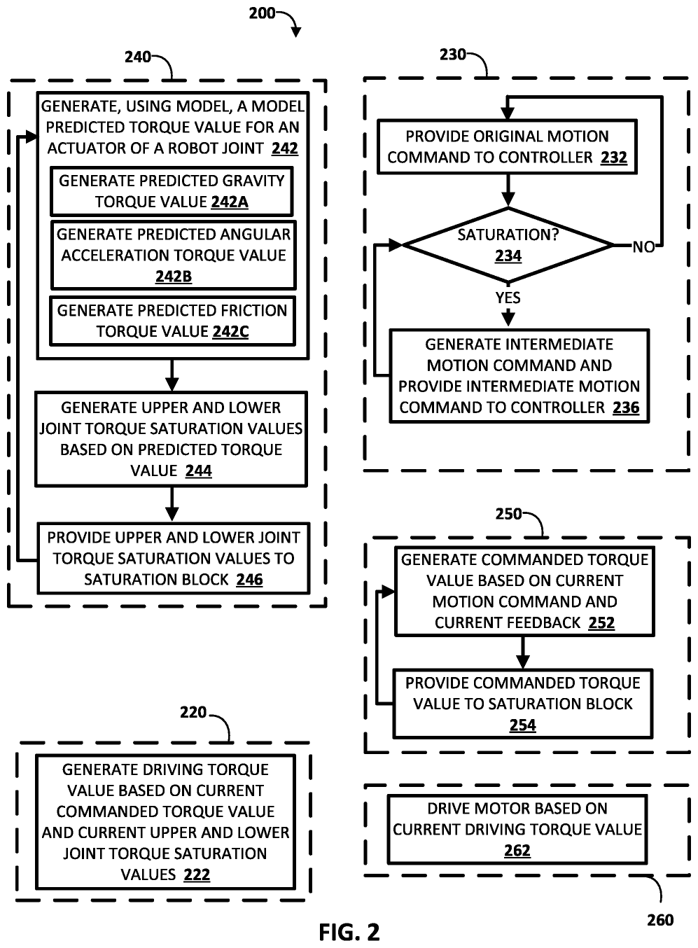

Turning now to FIG. 2 various example methods are illustrated in accordance with various implementations. In FIG. 2, an overall method 200 is illustrated, which can include performance of methods 220, 230, 240, 250, and 260 in parallel with one another. In various implementations, method 220 is performed by saturation block 120A, method 230 is performed by command mediator engine 130A, method 240 is performed by joint torque limits engine 140A, method 250 is performed by feedback controller 150A, and method 260 is performed by driver 160A. For ease in description, blocks of the methods 220, 230, 240, 250, and 260 will be described with respect to those corresponding components. However, more generally, each block of the methods described below can each be performed utilizing one or more processor(s) and/or analog component(s). The methods 220, 230, 240, 250, and 260 can be performed in parallel with one another but, optionally, one or more are performed at a different frequency relative to one or more others and/or one or more are performed in different processing thread(s) than one or more others and/or utilizing different processor(s) than one or more others. Further, the same or similar methods can be performed in parallel by corresponding component(s) for other joints 112B-112F, and can be performed based on corresponding joint commands for other joints.

Method 240 includes block 242, in which a joint torque limits engine generates a model predicted torque value for an actuator of a robot joint. In some implementations, block 242 includes sub-blocks 242A, 242B, and/or 242C.

At sub-block 242A, the joint torque limits engine generates a predicted gravity torque value, at sub-block 242B the system generates a predicted angular acceleration value, and at block 242C the system generates a predicted friction torque value. One or more of block 242 and/or sub-block(s) 242A, 242B, and/or 242C can include generating a corresponding value based on a measured and/or predicted current position of the robot joint (e.g., a joint space position and/or a cartesian position) and/or based on component(s) of an active motion command (or intermediate motion command). In implementations where sub-block(s) 242A, 242B, and/or 242C are included, at block 242 the joint torque limits engine generates the model predicted torque value as a function of the predicted gravity torque value, the predicted angular acceleration value, and/or the predicted friction torque value. Although particular sub-block(s) 242A, 242B, and 242C are illustrated, it is understood that the model predicted torque value can be generated based on additional and/or alternative discrete torque value(s) and that one or more of those discrete torque value(s) can be determined using additional and/or alternative model(s) and/or additional and/or alternative robot value(s) and/or environmental value(s). More generally, the model predicted torque value can be generated based on one or more model(s) and one or more of: a current measured or estimated state of the robot joint; a current measured or estimated state of additional robot joint(s); component(s) of a motion command (or intermediate motion command) to be achieved by the robot joint and/or other robot joint(s); environmental condition(s); a known payload of the robot; and/or other value(s).

Method 240 also includes block 244, in which the joint torque limits engine generates upper and lower torque saturation values based on the predicted torque value generated in a most recent iteration of block 242.

Method 240 also includes block 246, in which the joint torque limits engine provides the upper and lower joint torque saturation values to a saturation block. In method 240, the system then returns to block 242.

Method 230 includes block 232 in which a command mediator engine provides a most recently received original motion command to a controller. Block 232 can be performed at least in an initial iteration and/or when the decision of decision block 234 (described below) is “no”.

Method 230 also includes block 234, in which the command mediator engine determines whether the motor, of the robot joint, is in saturation. In some implementations, the command mediator engine determines whether the motor is in saturation based on comparison of a most recently fed back commanded torque value to a most recently fed back driving torque value. If, at block 234 the command mediator engine determines the motor is not in saturation, the system returns to block 232. If, on the other hand, at block 234 the command mediator engine determines the motor is in saturation, the system proceeds to block 236 and generates an intermediate motion command, and provides the intermediate motion command to the controller (in lieu of the original motion command). The command mediator engine then returns to decision block 234.

Method 250 includes block 252, in which a controller generates a commanded torque value based on the most recent current motion command provided by method 230, which will be either the most recent original motion command or a most recent intermediate motion command, and based on current feedback (e.g., that indicates a current joint position and/or a current motor velocity).

Method 250 also includes block 254, in which the controller provides the commanded torque value to the saturation block.

Method 220 includes block 222, in which the saturation block generates a driving torque value based on the commanded torque value most recently provided by method 250 and based on most recent upper and lower joint torque saturation values most recently provided by method 240. For example, the saturation block can generate a driving torque value based on the current commanded torque value, but limited by the most recent upper and lower joint torque saturation values.

Method 260 includes block 262, in which the driver drives the motor based on the current driving torque value.

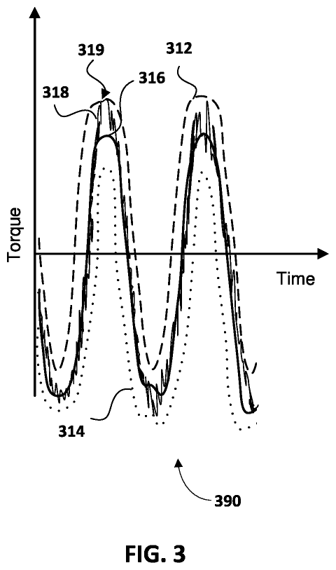

Turning now to FIG. 3, an example of sinusoidal currents 390 is provided, including a first 312 (dashed line) that corresponds to example upper torque saturation values, a second 314 (dotted line) that corresponds to example lower torque saturation values, a third 316 (solid thicker line) that corresponds to example model predicted torque values, and a fourth 318 (solid thinner line) that corresponds to example driving torque values.

The fourth 318 corresponds to the driving torque values that are actually utilized in controlling a motor. The first 312, the second 314, and third 316 are not actually provided to the motor in controlling the motor. However, the first 312, second 314, and third 316 are provided for reference since they can at least selectively influence the fourth 318. For example, from viewing FIG. 3 it can be seen that the first 312 and second 314 bound the third 316, demonstrating that the upper and lower torque saturation values bound the model predicted values and are based on adding to and subtracting from, respectively, the model predicted values.

Further, from viewing FIG. 3 it can be seen by the portion 319, of the fourth 318, that the driving torque is saturated at the portion 319, as a result of being bounded by the upper torque saturation values as described herein.

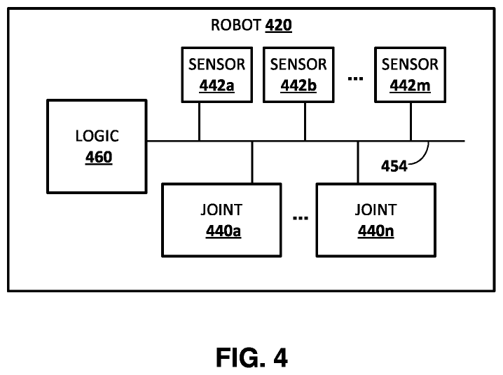

FIG. 4 schematically depicts an example architecture of a robot 420. Robot 420 includes logic 402. Logic 402 can take various forms, such as one or more processors (e.g., central processing unit(s), graphics processing unit(s), one or more field-programmable gate arrays (“FPGA”), one or more application-specific integrated circuits (“ASIC”), one or more analog component(s), and/or other component(s). In some implementations, logic 402 can be operably coupled with memory (not illustrated). Memory can take various forms, such as random access memory (“RAM”), dynamic RAM (“DRAM”), read-only memory (“ROM”), Magnetoresistive RAM (“MRAM”), resistive RAM (“RRAM”), NAND flash memory, and so forth. In various implementations, logic 402 can execute instructions, stored in coupled memory, to perform one or more of the methods described herein, such as method(s) 220, 230, 240, 250, and/or 260.

In some implementations, logic 402 can be operably coupled with one or more joints 440ₐ₋ₙ, one or more end effectors, and/or one or more sensors 442ₐ₋ₘ, e.g., via one or more buses 454. As used herein, a robot “joint” 440 may broadly refer to motors (e.g., servo motors), shafts, gear trains, pumps (e.g., air or liquid), pistons, drives, or other actuator(s) that may create and/or undergo propulsion, rotation, and/or motion. Some joints 440 are independently controllable, although this is not required. In some instances, the more joints robot 420 has, the more degrees of freedom of movement it may have. One or more of the joints 440 can be joints controlled according to techniques disclosed herein. Further, one or more of the joints 440 can optionally include, or be in communication with, a driver such as a driver disclosed herein. Additionally or alternatively, in some implementation(s) one or more of the joints 440 can include a position sensor and/or other sensor(s) of the sensors 442. In some of those implementations, one or more of the joints 440 can lack any torque sensor (e.g., any joint torque sensor and/or any force torque sensor).

As used herein, an “end effector” can refer to a variety of tools that can be operated by robot 420 in order to accomplish various tasks. For example, some robots can be equipped with an end effector that takes the form of a claw with two opposing “fingers” or “digits.” A claw is one type of “gripper” known as an “impactive” gripper. Other types of grippers can include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors can include but are not limited to drills, brushes, force-torque sensors, cutting tools, deburring tools, welding torches, containers, trays, fluid nozzles, and so forth. In some implementations, end effector 106 can be removable, and various types of modular end effectors may be installed onto robot 100, depending on the circumstances.

Sensors 442 can take various forms, including but not limited to 3D laser scanners or other 3D vision sensors (e.g., stereographic cameras used to perform stereo visual odometry) configured to provide depth measurements, two-dimensional cameras, “2.5D” cameras, light sensors (e.g., passive infrared), force sensors, pressure sensors, pressure wave sensors (e.g., microphones), proximity sensors (also referred to as “distance sensors”), depth sensors, torque sensors, bar code readers, radio frequency identification (“RFID”) readers, radars, range finders, accelerometers, gyroscopes, compasses, position coordinate sensors (e.g., global positioning system, or “GPS”), speedometers, edge detectors, and so forth. While sensors 442 are depicted as being integral with robot 420, this is not meant to be limiting. In some implementations, sensors 442 can be located external to, but may be in direct or indirect communication with, robot 420, e.g., as standalone units. In some implementations, sensors 442 can exclude any torque sensor(s). For example, sensors 442 can exclude any joint torque sensor and/or can exclude any force torque sensor.

In some implementations, a method is provided that includes generating, using one or more models for a robot joint of a robot, a model predicted torque value, for an actuator of the robot joint, in implementing a motion command for the robot joint. The method further includes generating, based on adding a value to the model predicted torque value, an upper torque saturation value. The method further includes generating, based on subtracting the value or an alternate value from the model predicted torque value, a lower torque saturation value. The method further includes generating, using a feedback controller and based on the motion command, a commanded torque value. The method further includes providing, to a saturation block that generates a driving torque value for driving the actuator: the commanded torque value, the upper torque saturation value, and the lower torque saturation value.

These and other implementations of the technology disclosed herein can include one or more of the following features.

In some implementations, providing the upper torque saturation value and the lower torque saturation value comprises providing an explicit indication of the upper torque saturation value and providing an explicit indication of the lower torque saturation value. In some implementations, providing the upper torque saturation value and the lower torque saturation value comprises providing the model predicted torque value and a deviation value, wherein the upper torque saturation value is indicated by the model predicted torque value plus the deviation value and wherein the lower torque saturation value is indicated by the model predicted torque value minus the deviation value.

In some implementations, generating the model predicted torque value includes: generating a predicted gravity torque value based on a current joint configuration of the robot joint and based on a mass model of the one or more models, and generating the model predicted torque value based on the predicted gravity torque value. In some of those implementations, the current joint configuration is based on: a measured or estimated current joint space position of the robot joint and/or one or more measured or estimated joint space positions of one or more additional joints of the robot.

In some implementations, generating the model predicted torque value includes generating a predicted angular acceleration torque value based on an acceleration component and based on a mass model of the one or more models, and generating the model predicted torque value based on the predicted angular acceleration torque value. The acceleration component can be of the motion command or can be an estimated or measured current acceleration of the robot joint.

In some implementations, generating the model predicted torque value includes: generating a predicted friction torque value based on a velocity component and a friction model of the one or more models, and generating the model predicted torque value based on the predicted friction torque value. The velocity component can be of the motion command or can be an estimated or measured current velocity of the robot joint.

In some implementations, generating the model predicted torque value includes generating the model predicted torque value based on a measured or estimated state of the robot joint, the motion command for the robot joint, one or more environmental conditions, and/or a payload of the robot.

In some implementations, generating the model predicted torque value includes generating one or more discrete predicted torque values, and generating the model predicted torque value as a function of the one or more discrete predicted torque values. In some of those implementations, the one or more discrete predicted torque values include a predicted gravity torque value, a predicted angular acceleration torque value, a predicted friction torque value, a predicted centripetal force value, a predicted Coriolis force value, and/or a predicted motor cogging torque value.

In some implementations, the motion command is generated based on user interface input or is generated by a higher level task planner of the robot.

In some implementations, the method further includes determining that the driving torque value is the upper torque saturation value or the lower torque saturation value and, in response to determining that the driving torque value is the upper torque saturation value or the lower torque saturation value: generating an intermediate motion command for the robot joint; generating, using the feedback controller and based on the intermediate motion command, an additional commanded torque value; and providing the additional commanded torque value to the saturation block. The intermediate motion command for the robot joint can include, for example: an intermediate position component that is lessened in magnitude relative to an original position component of the motion command and/or includes an intermediate velocity component that is lessened in magnitude relative to an original velocity component of the motion command. In some versions of those implementations, the method further includes determining that an additional driving torque value is no longer a saturation value and, in response to determining that the additional driving torque value is no longer a saturation value: generating, using the feedback controller and based on the motion command, a further additional commanded torque value; and providing the further additional commanded torque value to the saturation block. In some of those versions, the method further includes: generating, using the one or more models, an updated model predicted torque value, for the actuator of the robot joint, in implementing the motion command for the robot joint; generating, based on adding the value to the updated model predicted torque value, an updated upper torque saturation value; generating, based on subtracting the value or the alternate value from the model predicted torque value, an updated lower torque saturation value; and providing, to the saturation block and along with the additional commanded torque value, the updated upper torque saturation value and the updated lower torque saturation value. Optionally, generating the updated model predicted torque value can include: generating an updated predicted gravity torque value based on an updated current joint configuration of the robot joint, the updated current joint configuration being the result of prior driving of the actuator; and generating the updated model predicted torque value based on the updated predicted gravity torque value.

In some implementations, the method further includes selecting the value from a plurality of candidate values. In some of those implementations, selecting the value is based on: user interface input, whether any human is predicted to be present in an environment of the robot, and/or whether an interaction with an environmental object is predicted to occur.

In some implementations, the saturation block is implemented in a driver for the actuator. In some of those implementations, in generating the driving torque value for driving the actuator, the saturation block of the driver: generates the driving torque value based on the commanded torque value when the commanded torque value is less than the upper torque saturation value and is greater than the lower torque saturation value; generates the driving torque value based on the upper torque saturation value when the commanded torque value is equal to or greater than the upper saturation value; and generates the driving torque value based on the lower torque saturation value when the commanded torque value is equal to or lesser than the lower torque saturation value.

In some implementations, the method further includes generating, by the saturation block, a driving torque value of the driving torque values. In some of those implementations, generating the driving torque value includes: generating a driving torque value, of the driving torque values, based on the commanded torque value when the commanded torque value is less than the upper torque saturation value and is greater than the lower torque saturation value; generating the driving torque value based on the upper torque saturation value when the commanded torque value is equal to or greater than the upper saturation value; and generating the driving torque value based on the lower torque saturation value when the commanded torque value is equal to or lesser than the lower torque saturation value.

In some implementations, the method further includes generating, by the driver, a current that corresponds to the driving torque value and driving the actuator by providing the current to the actuator.

In some versions of those implementations, the saturation block is implemented separate from the driver, and the method further includes determining that the driving torque value is the upper torque saturation value or the lower torque saturation value and, in response to determining that the driving torque value is the upper torque saturation value or the lower torque saturation value: generating an intermediate motion command for the robot joint; generating, using the feedback controller and based on the intermediate motion command, an additional commanded torque value; and providing the additional commanded torque value to the saturation block. In some of those versions, the intermediate motion command for the robot joint includes: an intermediate position component that is lessened in magnitude relative to an original position component of the motion command and/or an intermediate velocity component that is lessened in magnitude relative to an original velocity component of the motion command.

In some implementations, a method of driving a robot actuator, of a robot, during performance of a task by the robot, is provided. The method includes receiving, at a driver for the robot actuator: a commanded torque value, an upper torque saturation value, and a lower torque saturation value. The method further includes generating, by the driver, a driving torque value for driving the robot actuator. Generating the driving torque value is based on the commanded torque value, but bounded by the upper torque saturation value and the lower torque saturation value. The method further includes driving the robot actuator based on the driving torque value. The method further includes receiving, at the driver and subsequent to generating the torque value (but during performance of the task by the robot): an additional commanded torque value, an additional upper torque saturation value that varies from the upper torque saturation value, and an additional lower torque saturation value that varies from the lower torque saturation value. The method further includes generating, by the driver, an additional driving torque value for driving the robot actuator, and driving the robot actuator based on the additional driving torque value. Generating the additional driving torque value is based on the commanded torque value, but bounded by the additional upper torque saturation value and the additional lower torque saturation value.

These and other implementations of the technology disclosed herein can include one or more of the following features.

In some implementations, the method further includes generating, by the driver, a current that corresponds to the driving torque value and generating, by the driver, an additional current that corresponds to the additional driving torque value. In those implementations, driving the actuator based on the driving torque value includes providing the current to the actuator, and driving the actuator based on the additional driving torque value includes providing the additional current to the actuator.

In some implementations, the upper torque saturation value and the lower torque saturation value are generated dynamically as a function of a predicted torque value that is based on a current state of the robot actuator.

In some implementations, the method further includes receiving, at the driver and from a controller that provides the commanded torque value, an integral value. In some of those implementations, generating the driving torque further includes using an anti-windup feature in generating the driving torque.

In some implementations, a method is provided that includes, at each of a plurality of time steps during performance of a task by the robot: generating, using a model for a robot joint of a robot and based on a corresponding current state of the robot joint, a corresponding model predicted torque value for an actuator of the robot joint; generating, based on adding a value to the corresponding model predicted torque value, a corresponding upper torque saturation value, generating, based on subtracting the value or an alternate value from the corresponding model predicted torque value, a corresponding lower torque saturation value; and providing, to a saturation block of a driver of an actuator of the robot joint, the corresponding lower torque saturation value and the corresponding upper torque saturation value.

In some implementations, a method of driving an actuator is provided and includes receiving, at a driver for the actuator and during driving of the actuator: a sequence of commanded torque values and a sequence of saturation limits. The method further includes generating, by the driver, a sequence of driving torque values for driving the actuator. Generating the sequence of driving torque values is based on the sequence of commanded torque values, but bounded by the sequence of saturation limits.

These and other implementations of the technology disclosed herein can include one or more of the following features.

In some implementations, generating the sequence of driving torque values includes, generating each of the driving torque values based on a most recently received commanded torque value of the sequence of commanded torque values, unless the most recently received commanded torque value violates most recently received saturation limits of the sequence of saturation limits. In some of those implementations, when the most recently received commanded torque value violates an upper limit of the most recently received saturation limits, the driving torque value is generated based on the upper limit—and when the most recently received commanded torque value violates a lower limit of the most recently received saturation limits, the driving torque value is generated based on the lower limit.

In some implementations, a driver for an actuator is provided and includes a first input for receiving commanded torque values, a second input for receiving dynamically generated upper saturation limits, and a third input for receiving dynamically generated lower saturation limits. The driver generates driving torque values that are based on the first input when the first input does not violate the second input or the third input, are based on the second input when the first input violates the second input, and based on the third input when the first input violates the third input.

Other implementations can include a non-transitory computer readable storage medium storing instructions executable by one or more processor(s) (e.g., a central processing unit(s) (CPU(s)), graphics processing unit(s) (GPU(s)), programmable logic controller(s) (PLC(s)), and/or tensor processing unit(s) (TPU(s))) to perform a method such as one or more of the methods described herein. Yet other implementations can include a system of one or more computers and/or one or more robots that include one or more processors and/or other component(s) that are operable to execute stored instructions to perform a method such as one or more of the methods described herein.

What is claimed is:

1. A method implemented by one or more components of a robot, the method comprising:
generating, using one or more models for a robot joint of a robot, a model predicted torque value, for an actuator of the robot joint, in implementing a motion command for the robot joint;
generating, based on adding a value to the model predicted torque value, an upper torque saturation value, and
generating, based on subtracting the value or an alternate value from the model predicted torque value, a lower torque saturation value;
generating, using a feedback controller and based on the motion command, a commanded torque value;
providing, to a saturation block that generates a driving torque value for driving the actuator:
the commanded torque value,
the upper torque saturation value, and
the lower torque saturation value.

2. The method of claim 1, wherein generating the model predicted torque value comprises:
generating a predicted gravity torque value based on a current joint configuration of the robot joint and based on a mass model of the one or more models; and
generating the model predicted torque value based on the predicted gravity torque value.

3. The method of claim 2, wherein the current joint configuration is based on:
a measured or estimated current joint space position of the robot joint, and
one or more measured or estimated joint space positions of one or more additional joints of the robot.

4. The method of claim 1, wherein generating the model predicted torque value comprises:
generating a predicted angular acceleration torque value based on an acceleration component and based on a mass model of the one or more models,
wherein the acceleration component is of the motion command or is an estimated or measured current acceleration of the robot joint; and
generating the model predicted torque value based on the predicted angular acceleration torque value.

5. The method of claim 1, wherein generating the model predicted torque value comprises:
generating a predicted friction torque value based on a velocity component and a friction model of the one or more models,
wherein the velocity component is of the motion command or is an estimated or measured current velocity of the robot joint; and
generating the model predicted torque value based on the predicted friction torque value.

6. The method of claim 1, wherein generating the model predicted torque value comprises generating the model predicted torque value based on one or more of:
a measured or estimated state of the robot joint,
the motion command for the robot joint,
one or more environmental conditions, or
a payload of the robot.

7. The method of claim 1, wherein generating the model predicted torque value comprises:
generating one or more discrete predicted torque values, the one or more discrete predicted torque values including one or more of:
a predicted gravity torque value,
a predicted angular acceleration torque value,
a predicted friction torque value,
a predicted centripetal force value,
a predicted Coriolis force value, or
a predicted motor cogging torque value; and
generating the model predicted torque value as a function of the one or more discrete predicted torque values.

8. The method of claim 1, wherein the motion command is generated based on user interface input or is generated by a higher level task planner of the robot.

9. The method of claim 1, further comprising:
determining that the driving torque value is the upper torque saturation value or the lower torque saturation value; and
in response to determining that the driving torque value is the upper torque saturation value or the lower torque saturation value:
generating an intermediate motion command for the robot joint, wherein the intermediate motion command for the robot joint includes:
an intermediate position component that is lessened in magnitude relative to an original position component of the motion command, and/or
an intermediate velocity component that is lessened in magnitude relative to an original velocity component of the motion command;
generating, using the feedback controller and based on the intermediate motion command, an additional commanded torque value; and
providing the additional commanded torque value to the saturation block.

10. The method of claim 9, further comprising:
after determining the predicted torque value is the upper torque saturation value or the lower torque saturation value:
determining that an additional driving torque value is no longer a saturation value; and
in response to determining that the additional driving torque value is no longer a saturation value:
generating, using the feedback controller and based on the motion command, a further additional commanded torque value; and
providing the further additional commanded torque value to the saturation block.

11. The method of claim 10, further comprising:
generating, using the one or more models, an updated model predicted torque value, for the actuator of the robot joint, in implementing the motion command for the robot joint;
generating, based on adding the value to the updated model predicted torque value, an updated upper torque saturation value;
generating, based on subtracting the value or the alternate value from the model predicted torque value, an updated lower torque saturation value; and
providing, to the saturation block and along with the additional commanded torque value, the updated upper torque saturation value and the updated lower torque saturation value.

12. The method of claim 11, wherein generating the updated model predicted torque value comprises:
generating an updated predicted gravity torque value based on an updated current joint configuration of the robot joint, the updated current joint configuration being the result of prior driving of the actuator; and
generating the updated model predicted torque value based on the updated predicted gravity torque value.

13. The method of claim 1, further comprising:
selecting the value from a plurality of candidate values.

14. The method of claim 13, wherein selecting the value is based on at least one of:
user interface input,
whether any human is predicted to be present in an environment of the robot, or
whether an interaction with an environmental object is predicted to occur.

15. The method of claim 1, wherein the saturation block is implemented in a driver for the actuator, and wherein in generating the driving torque value for driving the actuator, the saturation block of the driver:
generates the driving torque value based on the commanded torque value when the commanded torque value is less than the upper torque saturation value and is greater than the lower torque saturation value;
generates the driving torque value based on the upper torque saturation value when the commanded torque value is equal to or greater than the upper saturation value; and
generates the driving torque value based on the lower torque saturation value when the commanded torque value is equal to or lesser than the lower torque saturation value.

16. The method of claim 1, further comprising:
generating, by the saturation block, a driving torque value of the driving torque values, wherein generating the driving torque value comprises:
generating a driving torque value, of the driving torque values, based on the commanded torque value when the commanded torque value is less than the upper torque saturation value and is greater than the lower torque saturation value;
generating the driving torque value based on the upper torque saturation value when the commanded torque value is equal to or greater than the upper saturation value; and
generating the driving torque value based on the lower torque saturation value when the commanded torque value is equal to or lesser than the lower torque saturation value.

17. The method of claim 16, further comprising:
generating, by the driver, a current that corresponds to the driving torque value; and
driving the actuator by providing the current to the actuator.

18. The method of claim 16, wherein the saturation block is implemented separate from the driver, and further comprising:
determining that the driving torque value is the upper torque saturation value or the lower torque saturation value; and
in response to determining that the driving torque value is the upper torque saturation value or the lower torque saturation value:
generating an intermediate motion command for the robot joint, wherein the intermediate motion command for the robot joint includes:
an intermediate position component that is lessened in magnitude relative to an original position component of the motion command, and/or
an intermediate velocity component that is lessened in magnitude relative to an original velocity component of the motion command;
generating, using the feedback controller and based on the intermediate motion command, an additional commanded torque value; and
providing the additional commanded torque value to the saturation block.

19. A method comprising:
driving a robot actuator of a robot during performance of a task by the robot, the method, driving the robot actuator comprising:
receiving, at a driver for the robot actuator:
a commanded torque value,
an upper torque saturation value, and
a lower torque saturation value;
generating, by the driver, a driving torque value for driving the robot actuator, wherein generating the driving torque value is based on the commanded torque value but bounded by the upper torque saturation value and the lower torque saturation value;
driving the robot actuator based on the driving torque value;
receiving, at the driver and subsequent to generating the torque value:
an additional commanded torque value,
an additional upper torque saturation value that varies from the upper torque saturation value, and
an additional lower torque saturation value that varies from the lower torque saturation value;
generating, by the driver, an additional driving torque value for driving the robot actuator, wherein generating the additional driving torque value is based on the commanded torque value but bounded by the additional upper torque saturation value and the additional lower torque saturation value; and
driving the robot actuator based on the additional driving torque value.

20. The method of claim 19, further comprising:
generating, by the driver, a current that corresponds to the driving torque value; and
generating, by the driver, an additional current that corresponds to the additional driving torque value;
wherein driving the actuator based on the driving torque value comprises providing the current to the actuator; and
wherein driving the actuator based on the additional driving torque value comprises providing the additional current to the actuator.

21. The method of claim 19, wherein the upper torque saturation value and the lower torque saturation value are generated dynamically as a function of a predicted torque value that is based on a current state of the robot actuator.

22. The method of claim 19, further comprising:
receiving, at the driver and from a controller that provides the commanded torque value, an integral value;
wherein generating the driving torque further comprises using an anti-windup feature in generating the driving torque.

23. A method, comprising
at each of a plurality of time steps during performance of a task by the robot:
generating, using a model for a robot joint of a robot and based on a corresponding current state of the robot joint, a corresponding model predicted torque value for an actuator of the robot joint;
generating, based on adding a value to the corresponding model predicted torque value, a corresponding upper torque saturation value,
generating, based on subtracting the value or an alternate value from the corresponding model predicted torque value, a corresponding lower torque saturation value; and
providing, to a saturation block of a driver of an actuator of the robot joint, the corresponding lower torque saturation value and the corresponding upper torque saturation value.
